(19) United States
(12) Patent Application Publication
(10) Pub. No.: US 2009/0146447 A1
(43) Pub. Date: Jun. 11, 2009

(54) Adjustable motorcycle windshied mount

(76) Inventors: Michael Baretta, Lowell, MA (US); George Tgibides, Dracut, MA (US)

Correspondence Address: Russ Weinzimmer, 614 Nashua Street, Suite 53, Milford, NH, 03055, US

(21) Appl. No.: 11/999,774

(22) Filed: Dec. 7, 2007

(51) Int. Cl. B60J 1/02

(52) U.S. Cl. 296/96.21

(57) ABSTRACT

An adjustable apparatus and method are disclosed for supporting a variety of sizes and models of detached motorcycle windshields. The apparatus comprises a mounting frame, a supporting mechanism for attaching the frame to a wall, floor, table, or other surface, or for balancing the frame on a floor or other horizontal surface, and a plurality of windshield couplers, at least some of which are adjustable in position relative to the frame and to each other. In preferred embodiments, the windshield attaches to the frame in essentially the same manner as it attaches to a motorcycle. In further preferred embodiments, the frame attaches to a wall using a vertical column of fasteners, thereby allowing attachment to a single wall stud. Preferred embodiments further comprise a mechanism for supporting a motorcycle passenger backrest. The method includes providing the apparatus, adjusting the positions of the couplers, and attaching a windshield to the couplers.

### FIELD OF THE INVENTION

The invention relates generally to motorcycle accessory storage systems, and more particularly to an adjustable motorcycle windshield mounting device.

### BACKGROUND OF THE INVENTION

For a variety of reasons, motorcycle and motor scooter ownership and operation have become increasingly popular throughout the world both for transportation and recreation. These vehicles are commonly used for both long-distance, high-speed travel, and short-distance, low speed travel. Premium motorcycles come equipped with windshields to provide comfort and safety to the rider's upper body by deflecting bugs, rocks and other debris such as sand and pebbles. The windshield may additionally act to intercept the onrushing force of wind on the rider's exposed body parts. This minimizes fatigue, especially when used for long distance touring purposes.

In order to enhance the pleasurable aspects of a motorcycle ride, especially on short trips and recreational rides, it is sometimes desirable to operate the motorcycle without a windshield. Because of this, motorcycles, scooters, and the like are equipped with windshields intentionally made to be easily detachable, so that the owner can attach or detach the windshield quickly and without significant effort.

Motorcycle windshields need to be substantially transparent with desirable strength and durability. For this reason, they are typically made from shatter-resistant plastic or tempered glass. A detachable or removable motorcycle windshield includes one or more attachment mechanisms that secure the windshield to the front portion of the motorcycle, scooter, or the like. The attachment mechanisms can include a multitude of nuts and rivets, a wide variety of clamps or clinches, and/or other mounting mechanisms.

The typical shapes and the nature of the materials generally used in constructing motorcycle windshields present special storage problems. The windshields tend to be curved and cut in odd, irregular shapes, which makes them cumbersome to handle and store. When leaned against a wall or placed on a shelf or on the floor, there is a risk of scratching the windshield. Furthermore, glass windshields are in danger of cracking or breaking, especially if they fall over, while some windshields (particularly plastic windshields) are at risk of deformation or other damage if forces or pressure are exerted against them while stored.

Often, a floor stand or wall mount is used to hold a motorcycle windshield when it is not installed on the motorcycle. However, these mounts are usually specific to only one, or to a very small number of windshield models. Hence, a repair shop or owner of more than one model must purchase and use a plurality of mounts.

### SUMMARY OF THE INVENTION

An adjustable apparatus is disclosed which allows a variety of sizes and models of detachable/removable motorcycle and/or motor scooter windshields to be mounted to a wall or to a floor standing unit. The apparatus comprises a mounting frame, a supporting mechanism that attaches the frame to a wall or otherwise supports the mounting frame, and a plurality of windshield couplers that connect the mounting frame to mounting points on a detachable motorcycle windshield. At least some of the positions of the mounting fixtures on the mounting frame are adjustable in at least one of a horizontal direction and a vertical direction, and in a preferred embodiment the positions of all of the mounting fixtures on the mounting frame are adjustable in both the horizontal and vertical directions. In preferred embodiments, the same mounting fixtures and mechanics that are used to mount the windshield on a motorcycle are used to mount the windshield to the mounting frame.

In some preferred embodiments, the mounting frame has a large surface area suitable for display of logos, text, and/or other illustrations.

In preferred embodiments the supporting mechanism is a wall mount that attaches to a vertical surface and supports the mounting frame from behind. In some of these embodiments the wall mount can be attached to a single wall stud by a series of attaching means arranged essentially in a vertical column. In other preferred embodiments, the supporting mechanism is a stand that rests on or attaches to a horizontal surface and supports the mounting frame from below, while in still other preferred embodiments the supporting mechanism is a ceiling mount that can be attached to a ceiling or other horizontal surface from below.

In yet other preferred embodiments, the apparatus further comprises a passenger backrest attachment mechanism that allows a motorcycle or motor scooter passenger backrest to be attached to the apparatus.

In another general aspect of the invention, the apparatus comprises a rectangular mounting frame, a plurality of wall attachment connectors fixed to the mounting frame essentially in a vertical column in the horizontal center of the mounting frame, so as to allow attachment of the mounting frame to a single wall stud, and four windshield couplers positioned near the four corners of the mounting frame and attachable to the four mounting points of a detachable motorcycle windshield. All four of the windshield couplers are horizontally and vertically adjustable in position on the mounting frame, and allow a motorcycle or motor scooter windshield to be mounted on the frame in essentially the same manner that the windshield is mounted on a motorcycle or motor scooter.

### BRIEF DESCRIPTION OF THE DRAWINGS

FIG. 1 is a perspective view of a preferred embodiment of the adjustable motorcycle windshield mount that includes a motorcycle passenger backrest attachment mechanism, wherein the mount is fixed to a wall structure and is holding a detached motorcycle windshield and a motorcycle passenger backrest;

FIG. 2 is a perspective view from an angle of the preferred embodiment of FIG. 1;

FIG. 3 is a perspective view from an angle of the preferred embodiment of FIG. 1 without a motorcycle windshield or a motorcycle passenger backrest attached;

FIG. 4A is a perspective close-up view from an angle of the lower section of the preferred embodiment of FIG. 1, showing the lower two attachment points on the windshield positioned near the corresponding lower two windshield couplers on the windshield mount;

FIG. 4B is a perspective view from an angle of the preferred embodiment of FIG. 1 showing the lower two attachment points on the windshield engaged with the corresponding lower two windshield couplers on the windshield mount and the upper two attachment points on the windshield positioned near the corresponding upper two windshield couplers on the windshield mount;

FIG. 4C is a perspective view from an angle of the preferred embodiment of FIG. 1 showing all four of the attachment points on the windshield engaged with the corresponding windshield couplers on the windshield mount;

FIG. 5 is a perspective front view of a preferred embodiment wherein the mounting frame is an open rectangular design that is attachable to a wall and is inexpensive to manufacture;

FIG. 6 is a perspective view from the front of two adjustable windshield mounts attached to a wall and supporting motorcycle windshields and motorcycle passenger backrests of different sizes;

FIG. 7 is a perspective view from an angle of a preferred embodiment wherein a windshield mount is attached to a ceiling;

FIG. 8 is a perspective view of a preferred embodiment wherein a windshield mount is attached to a stand that supports the mount from below; and

FIG. 9 is a perspective view of a preferred embodiment wherein the windshield mount is supported in a vertical orientation by a right-angle supporting mechanism that attaches horizontally to a table;

### DETAILED DESCRIPTION OF PREFERRED EMBODIMENTS

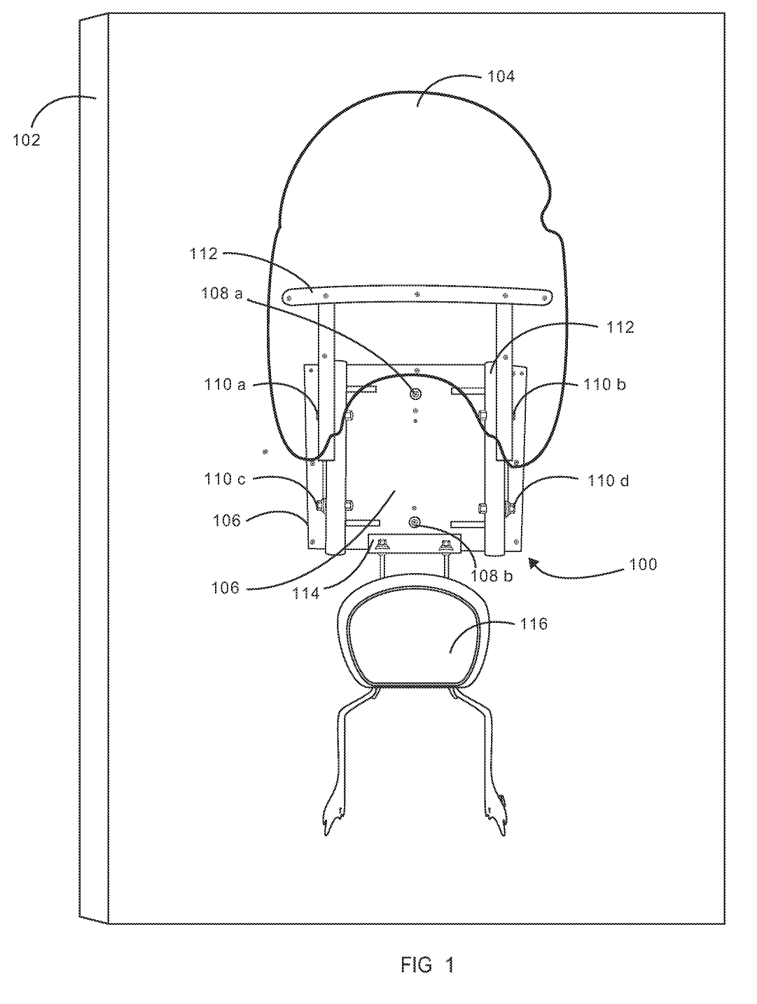

FIG. 1 is a perspective view from the front of a preferred embodiment of a motorcycle windshield mount 100 attached to a wall 102 and supporting a detached motorcycle windshield 104. The mount comprises a mounting frame 106, a supporting mechanism in the form of two supporting screws 108a 108b that attach the mounting frame 106 to the wall 102, and four windshield couplers 110a, 110b, 110c and 110d connected to two vertical tubes 112 that are attached in a horizontally adjustable manner to the mounting frame 106. The windshield couplers 110a, 110b, 110c, and 1190d are attachable to the mounting points (not shown) on the detached motorcycle windshield 104.

By adjusting the horizontal mounting locations of the vertical tubes 112 on the mounting frame 106, the horizontal distance between the windshield couplers 110a, 110b, 110c, and 110d can be adjusted. The detached motorcycle windshield 102 attaches to the mounting frame 106 in essentially the same manner as the windshield 102 attaches to a motorcycle (not shown). The mounting frame 106 in this embodiment has a large rectangular surface area suitable for display of logos, text and other illustrations. It attaches to the wall 102 using a plurality of wall attachment screws 108a and 108b that are arranged essentially in a vertical column. This feature allows the mounting frame 106 to be attached to a single wall stud (not shown).

The embodiment shown in FIG. 1 further includes a passenger backrest attachment mechanism 114 attached near the bottom of the mounting frame 106 that allows a motor cycle passenger backrest 116 to be suspended below the mounting frame 106.

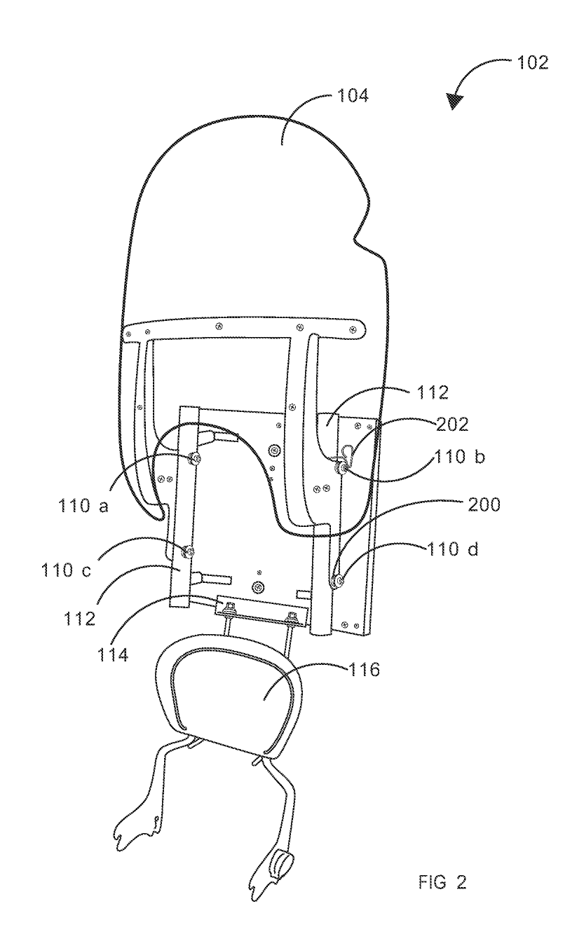

FIG. 2 is a perspective view from an angle of the preferred embodiment of FIG. 1. The windshield couplers 110a, 110b, 110c, and 110d are attached to corresponding mounting points 200, 202 on the detachable motorcycle windshield 102, thereby mounting the windshield 102 to the mounting frame 106.

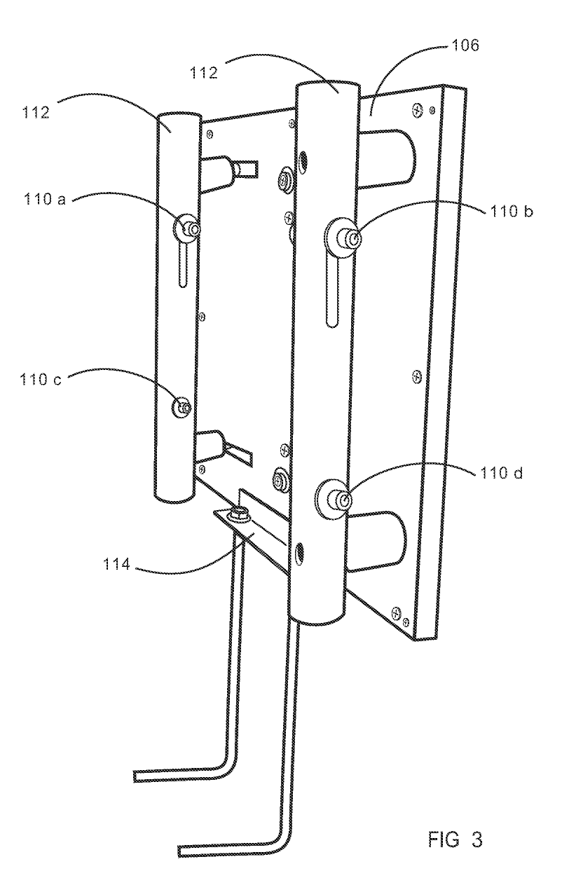

FIG. 3 is a perspective view from an angle of the preferred embodiment of FIG. 1, wherein neither a motorcycle windshield nor a motorcycle passenger backrest are supported by the apparatus. It can be seen in this figure that the upper two windshield couplers 110a, 110b attach to the vertical tubes through slotted holes, and are thereby adjustable in their vertical positions relative to the two lower windshield couplers 110c, 110d.

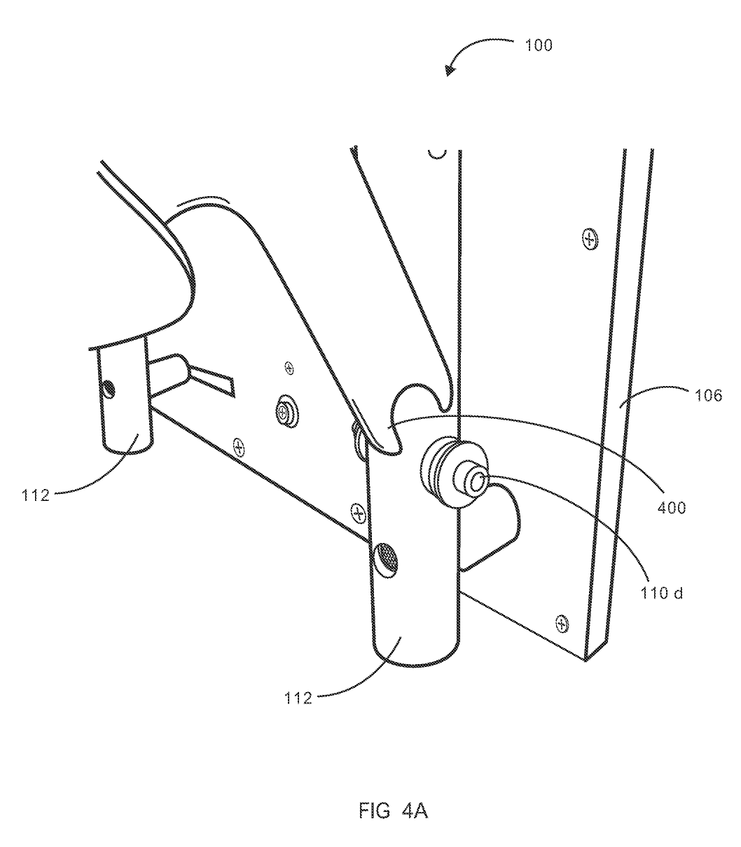

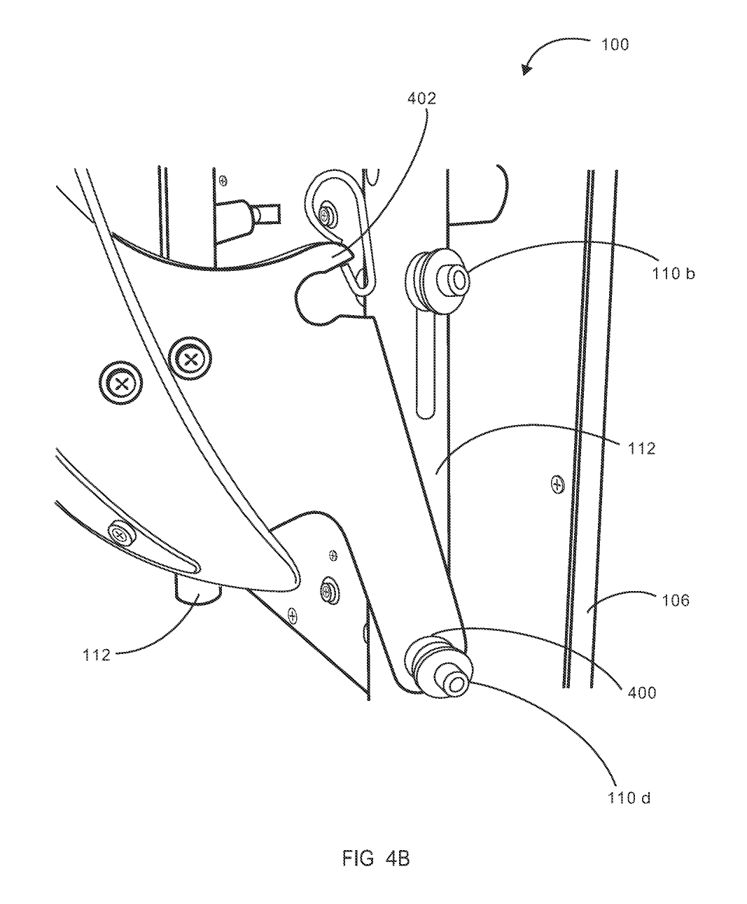

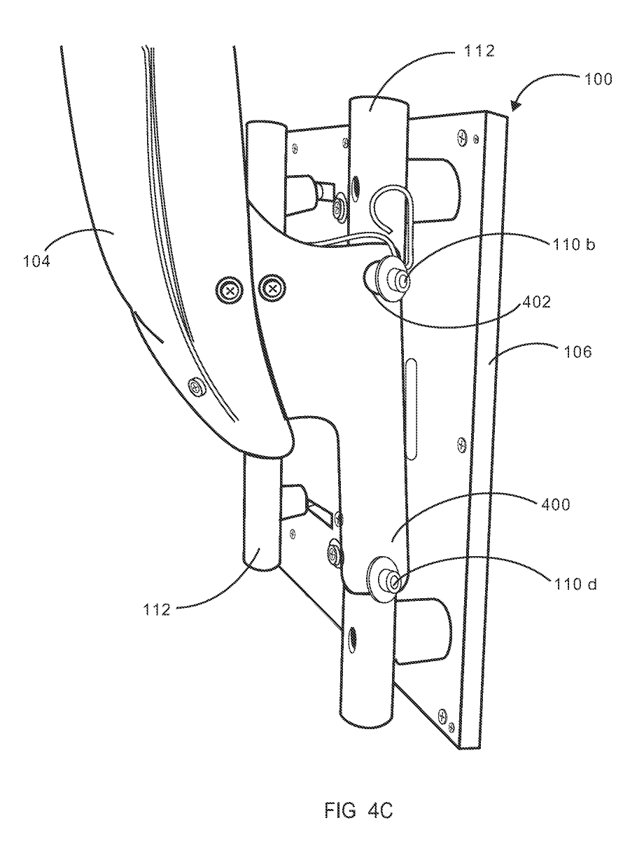

FIG. 4A, FIG. 4B and FIG. 4C are close-up views of the means of attachment of a motorcycle windshield to the preferred embodiment windshield mount of FIG. 1. With reference to FIG. 4A, the motorcycle windshield is initially inclined from its normal vertical orientation such that the left and right side lower mounting points 400 of the windshield align with the corresponding windshield couplers 110c (shown in FIG. 1), 110d attached to the frame 106 by means of the vertical tubes 112.

With reference to FIG. 4B, the lower mounting points 400 of the motorcycle windshield are attached to the corresponding windshield couplers 110c (shown in FIG. 1), 110d, and the windshield is rotated toward the vertical such that the upper windshield mounting points 402 are aligned with the upper windshield couplers 110a (shown in FIG. 1), 110b in essentially in the same manner that the windshield attaches to a motorcycle.

With reference to FIG. 4C, attachment of the motorcycle windshield 104 to the windshield mounting frame 106 is completed by attaching the upper windshield mounting points 402 to the upper windshield couplers 110a (shown in FIG. 1), 110b.

In the embodiment discussed above, the motorcycle windshield 104 is removed from the mounting frame 106 by reversing the process described above in reference to FIGS. 4A-4C.

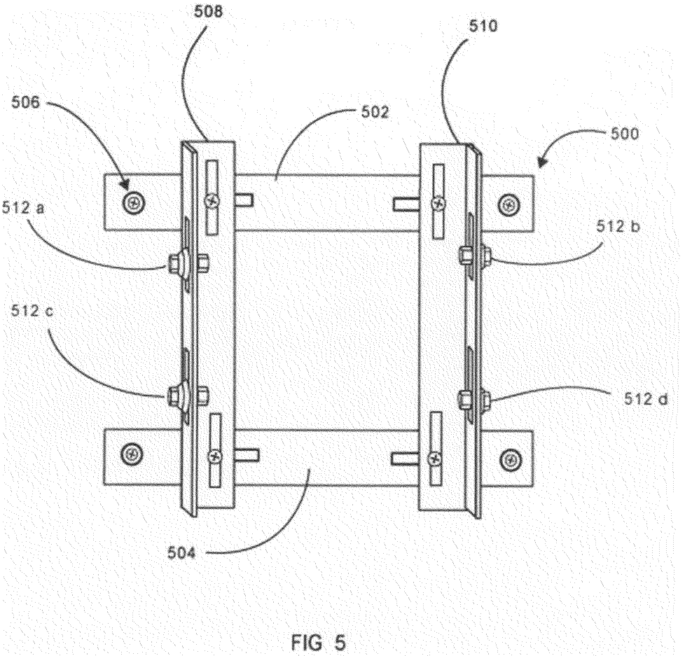

FIG. 5 illustrates a preferred embodiment that is inexpensive to produce and appropriate for attachment to a plywood wall or similar surface. In this embodiment, the windshield mount 500 includes a mounting frame comprising two flat horizontal brackets 502, 504 attached to a wall by screws 506 or other fasteners and offset from the wall by spacers (not shown), and two vertical angle brackets 508, 510 bolted to the flat horizontal brackets using slotted holes to allow the horizontal and vertical positioning of the vertical brackets 508, 510 to be adjusted. Windshield couplers 512a, 512b, 512c, and 512d are attached near the tops and bottoms of the vertical angle brackets 508, 510 using rectangular holes that allow the vertical distances between the couplers to be adjusted.

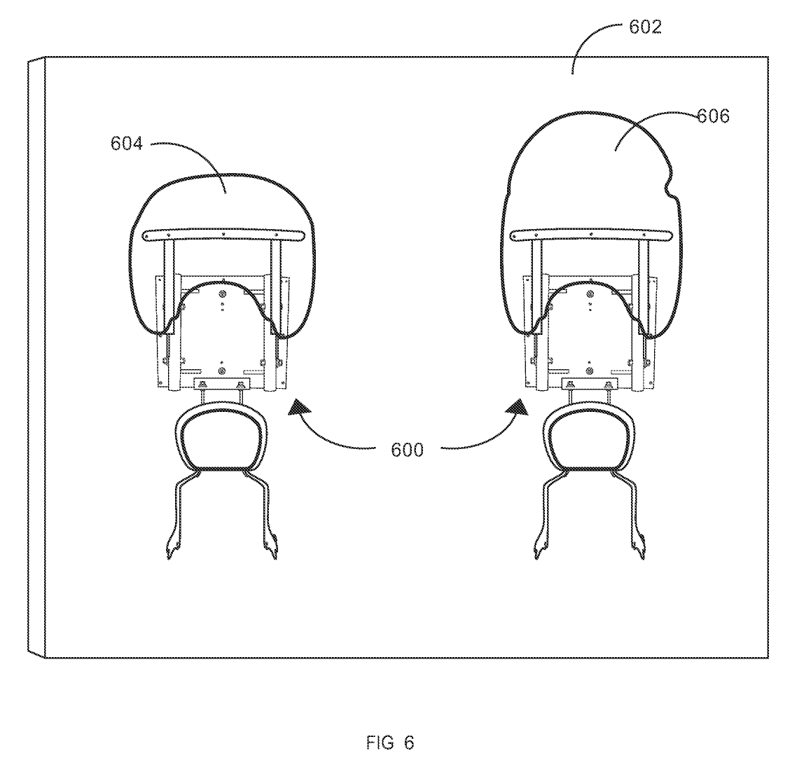

FIG. 6 illustrates two windshield mounts 600 of the preferred embodiment of FIG. 1 attached to a wall 602 and supporting two motorcycle windshields 604, 606 of different sizes.

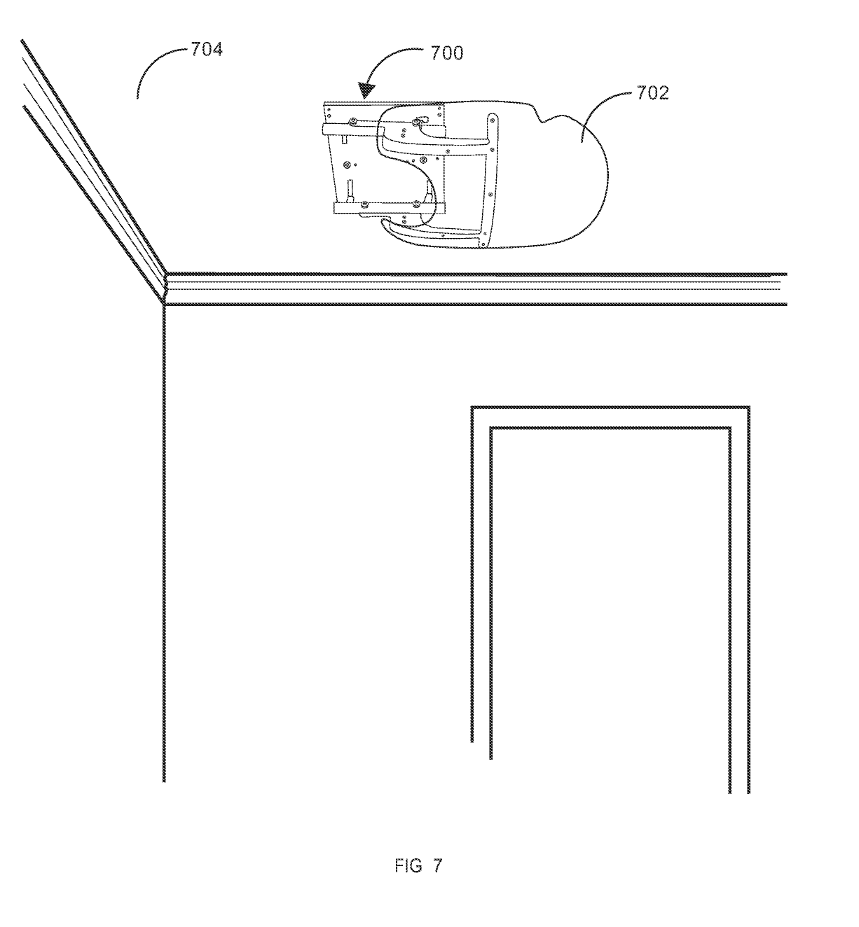

FIG. 7 illustrates a preferred embodiment wherein a motorcycle windshield mount 700 supports a motorcycle windshield 702 while attached to a ceiling 704.

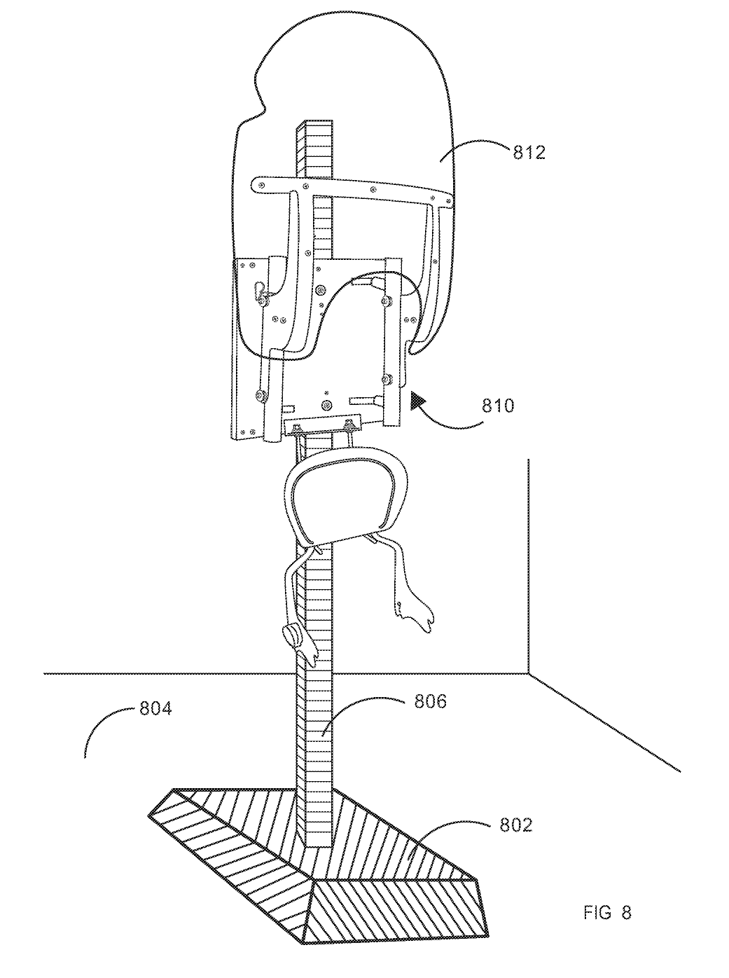

FIG. 8 illustrates a preferred embodiment wherein the supporting mechanism of a motorcycle windshield mount 800 is a stand comprising a base 802 that rests on a horizontal surface 804 and an upright member 806 that supports the mounting frame 810. In the preferred embodiment of FIG. 8, the base 802 of the stand is of sufficient dimensions and weight to resist tipping over when the mounting frame 810 is attached to a detachable motorcycle windshield 812. In similar preferred embodiments, the stand is attachable to the horizontal surface by screws or other attachment means so as to prevent the windshield mount from tipping over.

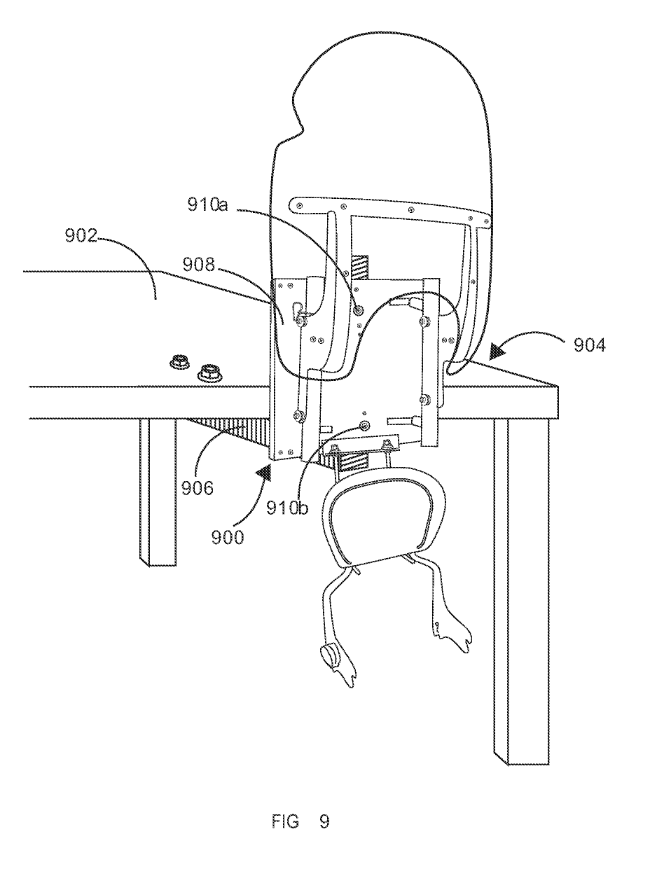

FIG. 9 illustrates a preferred embodiment wherein the windshield mount 900 is attached to the horizontal surface 902 of a table 904 by a supporting mechanism 906 that is shaped in a right angle, so as to attach to the table 904 in a horizontal orientation and support the windshield mount 900 in a vertical orientation. The mounting frame 908 of the windshield mount is attached to the supporting mechanism 906 by two screws 910a, 910b arranged essentially in a vertical column, thereby allowing attachment to the vertical member of the supporting mechanism 906, which in this embodiment is an upright post.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for supporting a detached motorcycle windshield, the apparatus comprising:
a mounting frame;
a supporting mechanism fixed to the frame; and
a plurality of windshield couplers connected to the mounting frame and attachable to mounting points on a detachable motorcycle windshield, at least some of the windshield couplers being adjustable in position on the mounting frame in at least one of a horizontal direction and a vertical direction.

2. The apparatus of claim 1, wherein the mounting frame has a large surface area suitable for display of logos, text, and other illustrations.

3. The apparatus of claim 1, wherein the detachable motorcycle windshield attaches to the plurality of windshield couplers in essentially the same manner as the windshield attaches to a motorcycle.

4. The apparatus of claim 1, wherein at least some of the windshield couplers are fixed to the mounting frame in a manner that allows their positions to be adjusted in both a horizontal direction and a vertical direction.

5. The apparatus of claim 1, wherein the supporting mechanism is a stand that rests on a horizontal surface and supports the mounting frame from below.

6. The apparatus of claim 5, wherein the stand includes a base that is able to balance the mounting frame and resists tipping over when the mounting frame is attached to a detachable motorcycle windshield.

7. The apparatus of claim 5, wherein the stand is attachable to the horizontal surface so as to prevent it from tipping over when the mounting frame is attached to a detachable motorcycle windshield.

8. The apparatus of claim 1, wherein the supporting mechanism is a ceiling mount that can be attached beneath a horizontal surface and can support the mounting frame from above.

9. The apparatus of claim 1, wherein the supporting mechanism is a wall mount that can be attached to a vertical surface and can support the mounting frame from behind.

10. The apparatus of claim 9, wherein the wall mount attaches to the vertical surface using a plurality of wall attachment connectors that are arranged essentially in a vertical column, thereby allowing the wall mount to attach to a single wall stud.

11. The apparatus of claim 1, wherein the apparatus further comprises a passenger backrest attachment mechanism so as to allow a motorcycle passenger backrest to be supported by the apparatus.

12. A wall mountable apparatus for supporting a detached motorcycle windshield, the apparatus comprising:
a rectangular mounting panel;
a plurality of wall attachment connectors fixed to the mounting panel essentially in a vertical column essentially in the horizontal center of the mounting panel; and
four windshield couplers connected to the mounting panel near the four corners of the panel and attachable to the four mounting points of a detachable motorcycle windshield, all of the windshield couplers being horizontally adjustable in position relative to the panel, and at least two of the windshield couplers being vertically adjustable in position relative to the panel.

13. A method for supporting a detached motorcycle windshield, the method comprising:
providing an apparatus for supporting a detached motorcycle windshield, the apparatus comprising a mounting frame, a supporting mechanism fixed to the frame, and a plurality of windshield couplers connected to the mounting frame and attachable to mounting points on a detachable motorcycle windshield, at least some of the windshield couplers being adjustable in position on the mounting frame in at least one of a horizontal direction and a vertical direction;
fixing the apparatus in a desired location and orientation using the supporting mechanism;
providing a detachable motorcycle windshield with mounting points;
adjusting the positions of at least some of the plurality of windshield couplers on the mounting frame of the apparatus so as to locate them in positions that are compatible with the locations of the mounting points of the windshield; and
attaching the windshield mounting points to the windshield couplers, thereby attaching the windshield to the apparatus.
